(19) United States
(12) Patent Application Publication
(10) Pub. No.: US 2006/0013726 A1
(43) Pub. Date: Jan. 19, 2006

(54) Biochemical reaction cartridge

(76) Inventor: Katsumi Munenaka, Tokyo (JP)

Correspondence Address: MORGAN & FINNEGAN, L.L.P., 3 WORLD FINANCIAL CENTER, NEW YORK, NY, 10281-2101, US

(21) Appl. No.: 11/181,006

(22) Filed: Jul. 12, 2005

(30) Foreign Application Priority Data
Jul. 14, 2004 (JP) 2004-207241

(51) Int. Cl. B01L 3/00

(52) U.S. Cl. 422/57; 422/100

(57) ABSTRACT

A biochemical reaction cartridge comprises a plurality of chambers for containing a solution for biochemically processing a sample, communication channels communicating with the chambers and connecting sections connected respectively to the communication channels, and the biochemical processor comprises connecting sections for controlling the air pressure in the cartridge through each of the communication channels, wherein each of the air communication channels being provided with a captor member for capturing any splash and/or volatilized matter of the sample itself, the solution for biochemically processing the sample or a mixture thereof.

### BACKGROUND OF THE INVENTION

1. Field of the Invention

This invention relates to a technique of analyzing cells, microorganisms, chromosomes, nucleic acids, etc., in a sample by utilizing a biochemical reaction such as antigen-antibody reaction or nucleic acid hybridization.

2. Related Background Art

Many analyzers for analyzing a sample such as blood employ an immunological technique that utilizes antigen-antibody reaction or a technique that utilizes nucleic acid hybridization.

For example, a protein such as antigen or antibody or a single-stranded nucleic acid that is capable of specifically bonding to a substance to be detected may be used as probe, which is fixed to the surface or surfaces of a solid phase such as micro-particles, beads or a glass plate, to give rise to antigen-antibody reaction or nucleic acid hybridization with the substance to be detected. Then, the resulting antigen-antibody compound or double-stranded nucleic acid is detected to by turn detect the presence or absence of or quantify the substance to be detected by means of a labeled substance such as a labeled antibody, a labeled antigen or a labeled nucleic acid that carries a highly sensitive labeling substance, for example, an enzyme, a fluorescent substance or a luminescent substance and shows a specific interaction.

For example, U.S. Pat. No. 5,445,934 discloses a DNA array formed by arranging a large number of DNA (deoxyribonucleic acid) probes having mutually different base sequences in an array on a substrate, as a development of the above described techniques.

Anal. Biochem., 270 (1), 103-111, 1999 discloses a method of preparing a protein array having a configuration similar to that of a DNA array by arranging proteins of many different types on a membrane filter. Thus, it is currently possible to examine a sample for a very large number of items by means of a DNA array or a protein array.

Meanwhile, disposable biochemical reaction cartridges that allow necessary reactions to take place in the inside have been proposed in order to reduce the contamination by samples, improve the efficiency of reactions, downsize the examination device and facilitate the operation. For example, Japanese Patent Application Laid-Open Publication No. H11-509094 discloses a biochemical reaction cartridge containing a DNA array and a plurality of chambers in the inside so as to allow extraction or amplification of DNA in the sample or cause a reaction such as hybridization to take place in the inside of the cartridge by driving solution to move by means of pressure difference.

An external syringe pump or a vacuum pump may be used to inject solution from the outside into the inside of such a biochemical reaction cartridge. The use of gravity, capillary phenomenon or electrophoresis is known as a technique for driving solution to move in the inside of a biochemical reaction cartridge. As for micro-pumps that are small and can be arranged in the inside of a biochemical reaction cartridge, Japanese Patent No. 2832117 discloses one that utilizes an exothermic element and Japanese Patent Application Laid-Open Publication No. 2000-274375 discloses a micro-pump that utilizes a piezoelectric element while Japanese Patent Application Laid-Open Publication No. H11-509094 discloses a diaphragm pump.

### SUMMARY OF THE INVENTION

As described above, proposals have been made for disposable biochemical reaction cartridges that are structurally so designed as not to contain any pump but to move a solution of a sample by means of an external pump once the sample is injected and cause a series of biochemical reactions to proceed without allowing the solution to flow out. However, such cartridges are still accompanied by the problem that they cannot satisfactorily prevent secondary infections and contaminations at a higher level.

To be more specific, when a sample solution or a solution for biochemically processing the sample is made to flow by itself or stirred to mix the solutions, the solution can partly become a splash and/or a volatilized matter and leave the solution to float in the air contained in the biochemical reaction cartridge.

While biochemical reaction cartridges of the type under consideration are provided with a connecting section to be connected to a biochemical processor that is equipped with a control section for controlling the air pressure in the cartridge, the splash and/or the volatilized matter can leak through the connecting section with air from the biochemical reaction cartridge to the outside or go into the inside of the biochemical processor.

Bacteria, viruses and/or other infectious matters may be found alive in a sample. In other words, they may hold their infecting potential in the sample. Therefore, it is a serious problem from the viewpoint of prevention of secondary contaminations if the sample leaks, if partly, with air from the biochemical reaction cartridge to the outside or go into the inside of the biochemical processor. Even if the bacteria, the viruses and/or the other infectious matters contained in the sample are subjected to a predetermined process in order to make them no longer infectious, some of their genes can go into the inside of the biochemical processor to give rise to contaminations. Then, it may not be possible to obtain the correct outcome of the antibody-antigen reaction or the nucleic acid hybridization. Furthermore, even a solution that is designed to biochemically process a sample and hence does not contain the sample can contaminate the inside of the biochemical processor to obstruct the intended proper biochemical reaction if it goes into the processor.

In an aspect of the present invention, there is providied a biochemical reaction cartridge comprising:
a plurality of chambers for containing a solution for biochemically processing a sample;
communication channels communicating with said chambers; and
connecting sections connected respectively to said communication channels;
each of said communication channels being provided with a captor member for capturing any splash and/or volatilized matter of the sample itself, the solution for biochemically processing the sample or a mixture thereof.

In another aspect of the present invention, there is provided a method of using a biochemical reaction cartridge, said biochemical reaction cartridge comprising:
a plurality of chambers for containing a solution for biochemically processing a sample;
communication channels communicating with said chambers; and
connecting sections connected respectively to said communication channels;
each of said communication channels being provided with a captor member for capturing any splash and/or volatilized matter of the sample itself, the solution for biochemically processing the sample or a mixture thereof;
said method being adapted to control the movement of liquid in the biochemical reaction cartridge by controlling the air pressure in the inside of said cartridge by way of the connecting sections.

Thus, the biochemical reaction cartridge and the method of using a cartridge according to the invention can effectively prevent any of the ingredients of the solution in the biochemical reaction cartridge from leaking with air to the outside of the biochemical reaction cartridge or going into the inside of the biochemical processor by arranging a means for capturing any splash and/or volatilized matter of the sample itself, the solution for biochemically processing the sample or a mixture thereof at the communication channels communicating with the chambers in the biochemical reaction cartridge containing a solution for biochemically processing a sample.

Particularly, any of the ingredients of the solution of the sample containing bacteria, viruses and/or other infectious matters keeping their infecting potential in the sample are prevented from leaking to the outside of the biochemical reaction cartridge to make it possible to prevent secondary infections at a high level and secure safety.

Additionally, any of the ingredients of the solution of the sample containing the bacteria, the viruses and/or the other infectious matters that have been subjected to a predetermined process in order to make them no longer infectious are also prevented from leaking with air to the outside of the biochemical reaction cartridge or going into the inside of the biochemical processor to make it possible to prevent contaminations and obtain the correct outcome of the antibody-antigen reaction or the nucleic acid hybridization.

Preferably, the captor member for capturing any splash and/or volatilized matter of the sample itself, the solution for biochemically processing the sample or a mixture thereof is realized in the form of an air permeable filter. Then, the captor member can effectively prevent secondary infections and contaminations. The filter may be selected from a filter of nonwoven fabric, a HEPA (high efficiency particulate air) filter, an ULPA (ultra low penetration air) filter, a germicidal enzyme filter and similar filters to exploit the functional features thereof. Particularly, when a germicidal enzyme filter is utilized as means for capturing a splash and/or a volatilized matter, the bacteria and/or the viruses that are captured would not propagate on the filter. Therefore, the use of such a filter is highly suitable from the viewpoint of securing safety.

When the means for capturing any splash and/or volatilized matter of the sample itself, the solution for biochemically processing the sample or a mixture thereof is realized by means of a fine tube structure of the communication channels or a labyrinth structure having bent sections of the communication channels, it is possible to manufacture a biochemical reaction cartridge according to the invention at low cost without using a filter and nevertheless effectively prevent any splash of the solution or the like in the biochemical reaction cartridge from leaking with air to the outside thereof. Furthermore, the advantages of the present invention can be effectively exploited even if the environment where a biochemical reaction cartridge according to the invention is used is not clean, although such a situation is not desirable in itself. For instance, a biochemical reaction cartridge according to the invention can effectively prevent a dust, bacteria and/or viruses from entering the inside of the biochemical reaction cartridge from the outside thereof in an environment where air contains a dust to a large extent unlike a clean room or an environment where bacteria and viruses are floating in the air such as the inside of the consulting room of a hospital where a large number of patients suffering from infective diseases gather. Thus, the present invention can effectively prevent contaminations in the broader sense of the word to provide an advantage of ensuring the reliability of the results of the analysis of an antibody-antigen reaction or a nucleic acid hybridization.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a schematic perspective view of a biochemical reaction cartridge according to the invention;

FIG. 2 is a schematic cross sectional plan view of the biochemical reaction cartridge;

FIG. 3 is a schematic illustration of a biochemical processor;

FIG. 4 is a schematic perspective view illustrating the configuration of a flow channel;

FIG. 5 is a schematic cross sectional view illustrating the configuration of a flow channel;

FIG. 6 is a flow chart of the operation of a biochemical processor;

FIG. 7 is a schematic cross sectional view of a part of the biochemical reaction cartridge of FIG. 1 taken across chambers thereof;

FIG. 8 is another schematic cross sectional view of a part of the biochemical reaction cartridge of FIG. 1 taken across chambers thereof;

FIG. 9 is a schematic cross sectional plan view of another biochemical reaction cartridge according to the invention;

FIG. 10 is a schematic perspective view illustrating the configuration of a flow channel;

FIG. 11 is a schematic cross sectional plan view of still another biochemical reaction cartridge; and

FIG. 12 is a schematic perspective view illustrating the configuration of a flow channel.

### DESCRIPTION OF THE PREFERRED EMBODIMENTS

Preferred embodiments of the present invention will now be described in detail in accordance with the accompanying drawings.

A biochemical reaction cartridge according to the invention comprises a plurality of chambers for containing a solution for biochemically processing a sample, communication channels communicating with the chambers and connecting sections connected respectively to the communication channels, each of the communication channels being provided with a capturing means for capturing any splash and/or volatilized matter of the sample itself, the solution for biochemically processing the sample or a mixture thereof. The communication channels, each of which is provided with a capturing means, communicate with the corresponding chambers, in which the viruses and/or other infectious matters that can be contained in the sample can exist in a state such that they are alive and can infect human bodies and other living bodies.

In this instance, the capturing means is a filter having air permeability, and is preferably selected from a filter of nonwoven fabric, a HEPA (high efficiency particulate air) filter, an ULPA (ultra low penetration air) filter, a germicidal enzyme filter and similar filters.

Preferably, the capturing means is realized by a fine tube structure of each of the communication channels and the fine tube structure is such that the communication channels communicating with the chambers have an average cross sectional area of not greater than 0.25 mm² and a length of not shorter than 15 mm between each chamber and the corresponding connecting section. Furthermore, two or more than two bent sections may be arranged on the way from the chamber to the connecting section of each communication channel, or the structure of each communication channel from the chamber to the connecting section may be a labyrinth structure.

The applicant of the present patent application proposed in Japanese Patent Application Laid-Open Publication No. 2003-94241 a disposable biochemical reaction cartridge that is structurally designed from the viewpoints of prevention of secondary infections or contamination and convenience of use so as not to contain any pump but to move solution by means of an external pump to cause a series of biochemical reactions to proceed without allowing the solution to flow out once the user injects the sample.

### Embodiment 1

Now, an embodiment of the present invention will be described by referring to the related drawings.

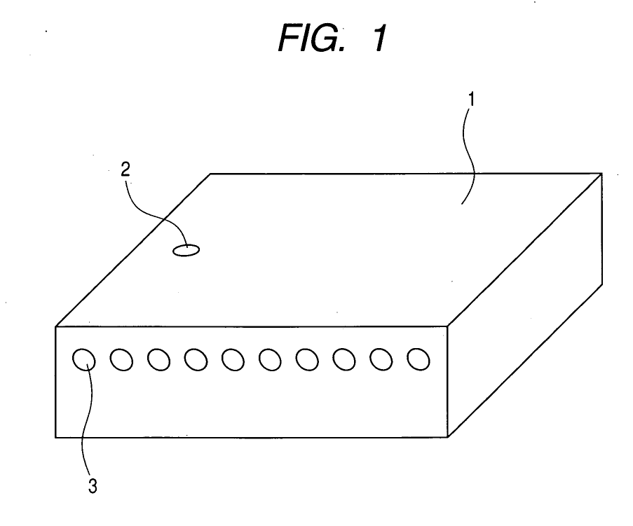

FIG. 1 is a schematic perspective view of this embodiment of biochemical reaction cartridge 1. An entrance 2 for a sample such as blood is arranged at the top of the cartridge 1 so as to be used when injecting the sample such as blood by means of e.g. a syringe. The entrance 2 is sealed by means of a rubber cap. A plurality of nozzle inlet ports 3 are arranged at a pair of oppositely disposed lateral surfaces of the cartridge 1 to operate as so many connecting sections for receiving nozzles for moving the solution in the inside by increasing or reducing the internal pressure. A rubber cap is fitted to each of the nozzle inlet ports 3, and the opposite side thereof has the same configuration.

The biochemical reaction cartridge 1 is made of transparent or semitransparent synthetic resin that may be polymethyl methacrylate (PMMA), acrylonitrile-butadiene-styrene (ABS) copolymer, polystyrene, polycarbonate, polyester, polyvinylchloride or the like. If no optical observation is required for the reaction product in the biochemical reaction cartridge 1, the material of its main body may not be transparent.

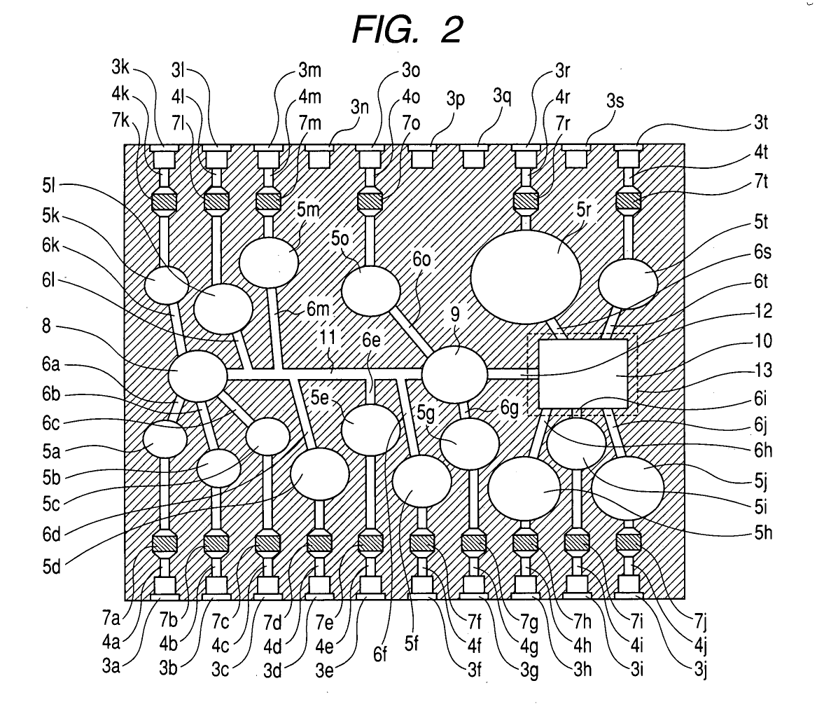

FIG. 2 is a schematic cross sectional plan view of the biochemical reaction cartridge 1. Referring to FIG. 2, a total of ten nozzle inlet ports 3a through 3j are arranged at one of the pair of lateral surfaces and another ten nozzle inlet ports 3k through 3t are arranged at the opposite lateral surface. Each of the nozzle inlet ports 3a through 3t is held in communication with the corresponding one of the chambers 5 (5a through 5t), which is a site for storing solution or causing a reaction to take place, by way of the corresponding one of airflow channels 4 (4a through 4t) that are communication channels through which airflows.

Note, however, that the nozzle inlet ports 3n, 3p, 3q and 3s are not in use and hence the flow channels 4n, 4p, 4q and 4s and the chambers 5n, 5p, 5q and 5s do not exist. In other words, the nozzle inlet ports 3n, 3p, 3q and 3s are spares. Thus, the nozzle inlet ports 3a through 3j arranged at one of the opposite lateral surfaces are respectively held in communication with the chambers 5a through 5j by way of the flow channels 4a through 4j, while the nozzle inlet ports 3k, 31, 3m, 3o, 3r and 3t arranged at the other lateral surface are respectively held in communication with the chambers 5k, 51, 5m, 5o, 5r and 5t by way of the flow channels 4k, 41, 4m, 4o, 4r and 4t.

The flow channels 4a through 4j and the flow channels 4k, 41, 4m, 4o, 4r and 4t are provided respectively on the way thereof with filters 7a through 7j and filters 7k, 71, 7m, 7o, 7r and 7t that are made of nonwoven fabric in order to capture any splash and/or volatilized matter of the sample, the solution for biochemically processing the sample or a mixture thereof. How the filters 7 are formed to the biochemical reaction cartridge 1 will be described later

The filters made of nonwoven fabric may be replaced by HEPA (high efficiency particulate air) filters or ULPA (ultra low penetration air) filters that are popular as air filters if they are compactly molded and incorporated into the flow channels. Particularly, ULPA (ultra low penetration air) filters have a capability of capturing particles that are as small as 0.1 μm and floating in air so that such filters can suitably be used for the purpose of the present invention. When germicidal enzyme filters are used, the captured bacteria and/or viruses are killed instantaneously by the function of the bacteriolytic enzyme that is fixed to the filter fibers. Then, there is no risk that bacteria and/or viruses propagate in the cartridge 1 and hence the use of germicidal enzyme filters can bring forth the most reliable effect of preventing secondary infections as safety measures.

While filters made of nonwoven fabric are used alone in this embodiment, any of the above cited different filters may be combined for use for the purpose of the present invention.

The entrance 2 for the sample communicates with chamber 8. The chambers 5a, 5b, 5c and 5k communicate with the chamber 8, while the chambers 5g and 5o communicate with chamber 9 and the chambers 5h, 5i, 5j, 5r and 5t communicate with chamber 10. The chamber 8 communicates with the chamber 9 by way of flow channel 11 and the chamber 9 by turn communicates with the chamber 10 by way of flow channel 12. The flow channel 11 communicates with the chambers 5d, 5e, 5f, 51 and 5m respectively by way of flow channels 6d, 6e, 6f, 61 and 6m.

The chamber 10 is provided at the bottom surface thereof with an angular hole and a DNA micro-array 13 (not shown, see FIG. 8) formed by arranging DNA probes of tens to hundreds of thousands different types highly densely on the surface of a solid phase such as a glass plate of the size of a square inch is applied to the angular hole with the probe carrying surface thereof facing upward.

By using the DNA micro-array 13, it is possible to examine a large number of genes at a time by conducting a reaction of hybridization with the DNA of the sample. The DNA probes are regularly arranged in the form of matrix so that the address (in terms of row and column) of each DNA probe can be easily acquired as information. Genes that are objects of examination may be those of infectious viruses or bacteria, disease-related genes or genes showing the genetic polymorphisms of an individual.

The first hemolyzing agent containing EDTA (ethylenediaminetetraacetic acid) and the second hemolyizing agent containing a protein denaturant such as surfactant are respectively accumulated in the chambers 5a and 5b. Magnetic particles that are coated with silica in order to adsorb DNA are accumulated in the chamber 5c, while the first and second extractant/detergent solutions are accumulated respectively in the chambers 51 and 5m for the purpose of extracting and refining DNA.

An agent containing a buffer solution of a low concentration salt for dissolving and extracting DNA from the magnetic particles is filled in the chamber 5d, while a mixed solution of primer, polymerase, dNTP solution, buffer and Cy-3dUTP containing a fluorescent agent that are necessary for PCR (polymerase chain reaction) is filled in the chamber 5g. A detergent for washing the fluorescence-labeled sample DNA that has not been hybridized and the fluorescent labeling substance are accumulated in the chambers 5h and 5j, while alcohol for drying the inside of the chamber 10 that contains the DNA micro-array 13 is accumulated in the chamber 5i.

The chamber 5e is a chamber for receiving and storing the dust of blood other than DNA and the chambers 5f is a chamber for receiving and storing the waste solution of the first and second extractant/detergent solutions of the chambers 51 and 5m, while the chamber 5r is a chamber for receiving and storing the waste solution of the first and second cleaning agents and the chambers 5k, 5o and 5t are blank chambers arranged to prevent any solution from flowing into the nozzle inlet ports.

As the liquid sample such as blood is injected into the biochemical reaction cartridge 1 and the latter is set in position in a processor, which will be described in greater detail hereinafter, the DNA and other substances are extracted and amplified in the inside of the cartridge 1 and additionally hybridization takes place between the amplified sample DNA and the DNA probes on the DNA micro-array in the inside of the cartridge 1. Then, the fluorescence-labeled sample DNA that has not been hybridized and the fluorescent labeling substance are washed.

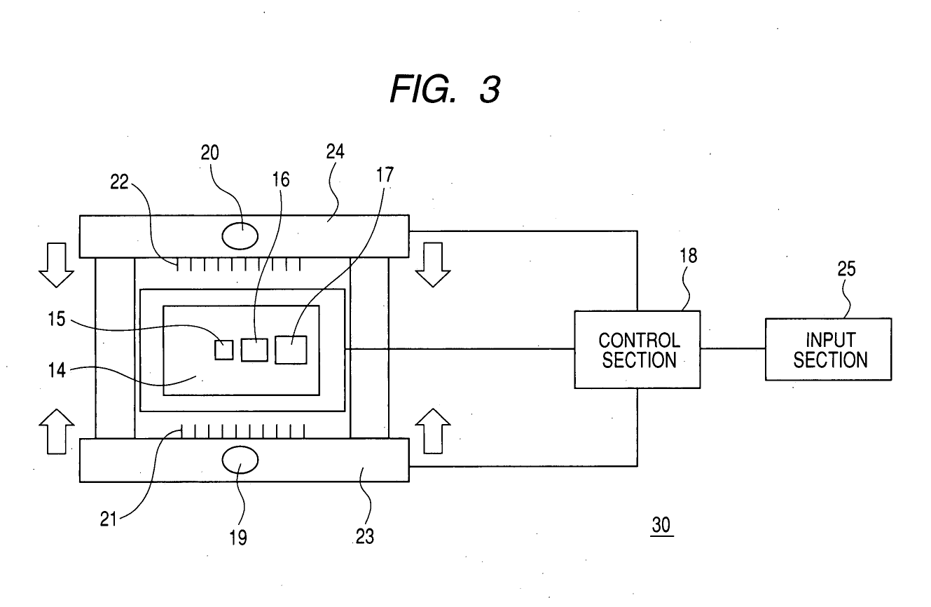

FIG. 3 is a schematic illustration of a biochemical processor 30 for controlling the movements of solutions and various reactions in the biochemical reaction cartridge 1. Referring to FIG. 3, table 14 is the place where the biochemical reaction cartridge 1 is set in position. An electromagnet 15 to be operated when extracting DNA and other substances from the sample in the biochemical reaction cartridge 1, a Peltier element 16 for controlling temperature when amplifying the DNA from the sample typically by means of PCR (polymerase chain reaction) and another Peltier element 17 for controlling temperature when causing hybridization of the amplified sample DNA and the DNA probes on the DNA micro-array 13 in the inside of the cartridge 1 to take place and when the sample DNA that has not been hybridized is washed. These elements are connected to a control section 18 for controlling the overall operation of the processor.

Pump blocks 23 and 24 are arranged respectively at opposite lateral sides of the table 14. Motor-driven syringe pumps 19 and 20 and a plurality of pump nozzles 21 and 22 that operate as inlet/outlet ports for ejecting or suctioning air by means of the pumps 19 and 20 are arranged on the respective tables 14. A total of ten pump nozzles are arranged at each lateral side. A plurality of motor-driven transfer valves (not shown) are arranged between the motor driven syringe pumps 19 and 20 and the corresponding pump nozzles 21 and 22 and connected to the control section 18 along with the motor-driven syringe pumps 19 and 20. The control section 18 is connected to an input section 25 to be operated by the examiner for input operations to control the operation of selectively opening one of the ten pump nozzles 21 or 22 at each side relative to the motor-driven syringe pump 19 or 20, whichever appropriate, or closing all the pump nozzles and also the operation of the Peltier elements 16 and 17 according to the information transmitted from the input section 25.

If the sample is blood, as the examiner injects blood into the embodiment of biochemical reaction cartridge 1 through the rubber cap of the entrance 2 for the sample by means of a syringe, the injected blood flows into the chamber 8. Subsequently, the examiner places the biochemical reaction cartridge 1 on the table 14 and drives the pump blocks 23 and 24 in the direction of the arrow in FIG. 3 by operating a lever (not shown) to insert the pump nozzles 21 and 22 into the nozzle inlet ports 3 at the opposite lateral sides of the cartridge 1 through the respective rubber caps.

Since the nozzle inlet ports 3a through 3t concentrate at the two surfaces of the two lateral sides of the biochemical reaction cartridge 1, it is possible to simplify the motor-driven syringe pumps 19 and 20, the motor-driven transfer valves and the pump blocks 23 and 24 containing the pump nozzles in terms of profile and positional arrangement. Additionally, it is possible to insert the pump nozzles 21 and 22 by a simple operation of pinching the cartridge 1 by means of the pump blocks 23 and 24 at a time, while securing the necessary chamber 5 and the necessary flow channel. Therefore, it is also possible to simplify the configuration of the pump blocks 23 and 24. Furthermore, when all the nozzle inlet ports 3a through 3t are arranged at the same level and aligned, all the flow channels 4a through 4t connected to the respective nozzle inlet ports 3a through 3t are also held at the same level to facilitate the manufacture of the flow channels 4a through 4t.

If the length of the pump blocks 23 and 24 is multiplied by n for n aligned biochemical reaction cartridges 1 in the processor of FIG. 3, all the n cartridges 1 can be operated simultaneously. Then, it is possible to operate a large number of cartridges for biochemical reactions with a simple configuration.

While the main body of the biochemical reaction cartridge 1 may be manufactured by way of any of a number of different processes, the flow channels 4, the chambers 5, the flow channels 6, the chambers 8 through 10 and the flow channels 11 and 12 can be arranged three-dimensionally by forming several layered structures by means of a synthetic resin material as pointed out above and laying and bonding them together.

When the flow channels 4a through 4t are arranged at the same level as pointed out above, they can be formed along the interface of the two layers that are bonded together to constitute the main body of the biochemical reaction cartridge 1.

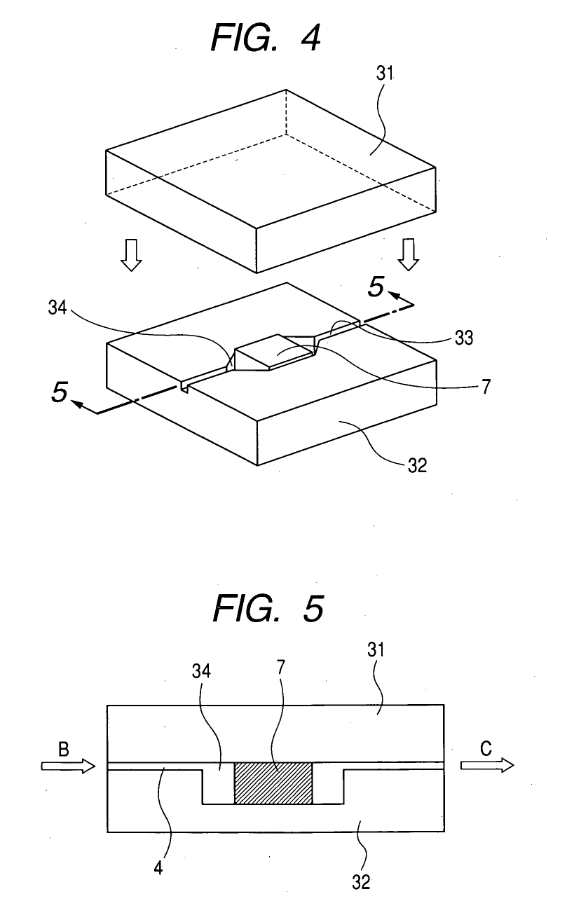

FIG. 4 is a schematic perspective view of a part of the embodiment of biochemical reaction cartridge 1, illustrating how a filter 7 is formed and set in position on a flow channel 4 when manufacturing the biochemical reaction cartridge 1. In FIG. 4, the biochemical reaction cartridge 1 is formed by bonding the uppermost layer 31 and the second uppermost layer 32. The second layer 32 is provided with a groove 33 and a space 34 is formed on the groove 33 by expanding the groove 33 in terms of both width and depth. The filter 7 is arranged in the space 34. As the uppermost layer 31 and the second layer 32 are laid one on the other bonded together, the groove 33 becomes a tubular flow channel 4. The filter 7 preferably has a thickness slightly greater than the depth of the groove 33 because it will be crushed to a slight extent to fill the space 34 when the two layers are put together. The flow channel 4 has a cross sectional area of about 0.1 to 1.0 mm² while the filter 7 has a cross sectional area of about 5.0 to 50.0 mm², which is five to five hundreds times greater than the cross sectional area of the flow channel 4. In other words, the filter 7 can hardly obstruct the flow of air that is produced by the motor-driven syringe pumps 19 and 20. Additionally, the flow rate of air passing through the filter 7 is lower than the flow rate of airflowing through the flow channel 4 so that the filter 7 can reliably capture the splash and/or the volatilized matter of the solution in the cartridge 1 and/or the dust in the air.

FIG. 5 is a schematic cross sectional view of a part taken along line 5-5 in FIG. 4. As described above, reference symbol 31 denotes the uppermost layer and reference symbol 32 denotes the second uppermost layer. As the uppermost layer 31 and the second layer 32 are laid one on the other bonded together, the groove 33 provided on the second layer 32 becomes a tubular flow channel 4. An air-permeable filter 7 is set in the space 34 on the flow channel 4. In FIG. 5, arrow B indicates the airflow moving through the corresponding chamber 5 in the biochemical reaction cartridge 1. A splash and/or a volatilized matter containing bacteria and/or viruses that once existed in the sample can be borne in the airflow. The filter 7 can capture the fine particles of the splash and/or the volatilized matter. Therefore, the airflow coming out after passing through the filter as indicated by arrow C in FIG. 5 does not bear any splash and/or volatized matter containing bacteria and/or viruses that once existed in the sample. Nor it bears any agents and other components found in the biochemical reaction cartridge 1. In this way, it is possible to flow clean air to the biochemical processor 30.

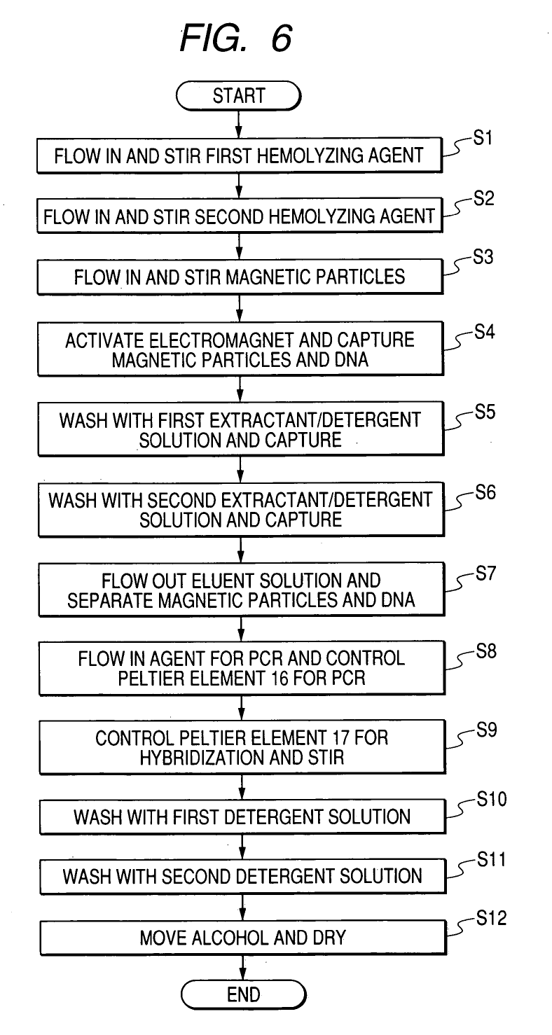

A process starts when the examiner inputs a command to the input section 25 to start the process. FIG. 6 is a flow chart of the operation of the biochemical processor using the embodiment of biochemical reaction cartridge. Referring to FIG. 6, firstly in Step S1, the control section 18 opens only the nozzle inlet ports 3a, 3k and ejects air from the motor-driven syringe pumps 19 and suctions air from the motor-driven syringe pump 20 to flow the first hemolyzing agent from the chamber 5a into the chamber 8 containing blood. At this time, it is advisable to start suctioning air from the motor-driven syringe pump 20, 10 to 200 milliseconds after the start of ejecting air from the motor-driven syringe pump 19 because then the flowing solution would not fly out at the leading end thereof and the solution would flow smoothly, although the timing of starting suctioning air may depend on the viscosity of the hemolyzing agent and the resistance of the flow channel.

Thus, it is possible to flow the solution smoothly by providing a time lag between the start of supplying air and the start of suctioning air in order to raise and reduce the air pressure under control. Additionally, it is possible to flow the solution more smoothly by controlling the operation of suctioning air by means of the motor-driven syringe pump 20 so as to linearly increase the flow rate from the start of supplying air from the motor-driven syringe pump 19. The solution can be driven to move under control in a similar manner also in later stages of operation.

The supply of air can be controlled with ease by means of the motor-driven syringe pumps 19 and 20. More specifically, only the nozzle inlet ports 3a and 3o are opened and air is ejected and suctioned alternately and repeatedly by means of the motor-driven syringe pumps 19 and 20. In this way, the operation of driving the solution in the chamber 8 to flow to the flow channel 11 and driving it to flow back is repeated in order to stir the solution. Alternatively, air may be continuously ejected from the motor-driven syringe pump 20 to generate air bubbles, which by turn stir the solution.

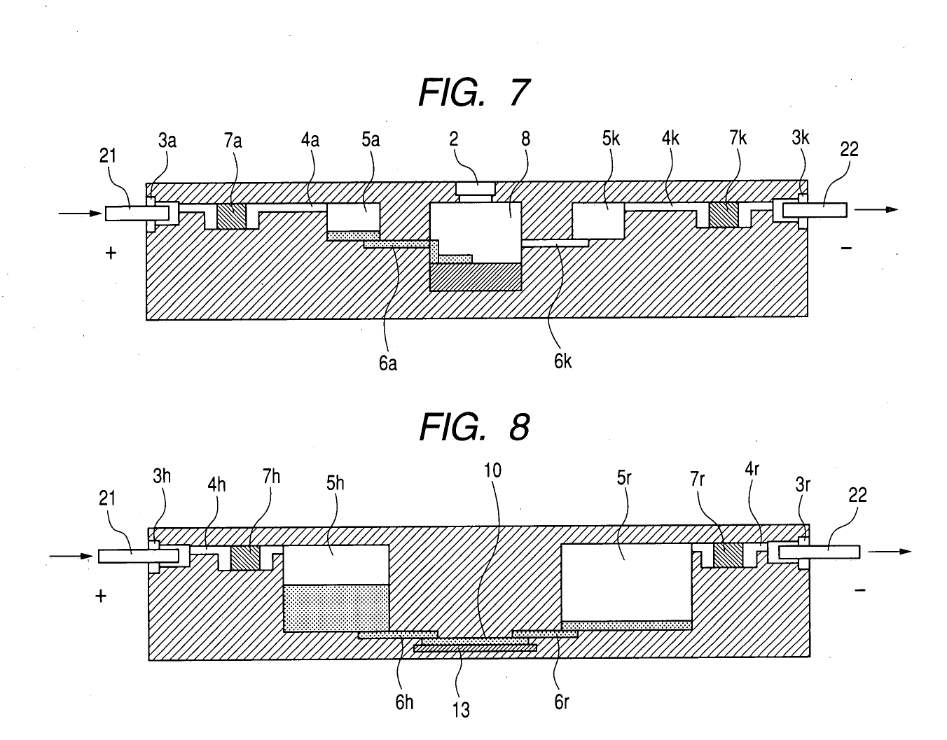

FIG. 7 is a schematic cross sectional view of a part of the embodiment of biochemical reaction cartridge taken across the chambers 5a, 8 and 5k. It shows that the pump nozzle 21 is inserted into the nozzle inlet port 3a to increase the internal pressure, while the pump nozzle 22 is inserted into the nozzle inlet port 3k to decrease the internal pressure so as to flow the first hemolyzing agent in the chamber 5a into the chamber 8 containing blood. The filter 7a is arranged on the flow channel 4a, while the filter 7k is arranged on the flow channel 4k.

The chamber 8 contains blood, which is the sample as pointed out above. The blood can by turn contain bacteria and/or viruses that are still alive. The first hemolyzing agent in the chamber 5a is driven to flow into the blood in the chamber 8 and, at this time, the first hemolyzing agent and the blood can fly out into the ambient air to produce a splash as they are mixed with each other. The possibility that the blood partly flies out to produce a splash that may float in the air is particularly high when only the nozzle inlet ports 3a and 3o are opened and air is ejected and suctioned alternately and repeatedly by means of the motor-driven syringe pumps 19 and 20 in order to repeat the operation of driving the solution in the chamber 8 to flow to the flow channel 11 and driving it to flow back for the purpose of stirring the solution or when air is ejected continuously from the motor-driven syringe pump 20 to generate air bubbles, which by turn stir the solution.

In this embodiment, filters 7a through 7j, 7k, 7l, 7m, 7o, 7r and 7t that are made of nonwoven fabric are arranged respectively on the flow channels 4a through 4j, 4k, 4l, 4m, 4o, 4r and 4t. The fine particles of the splash that float in the air have a size of about 1 μm and include small ones of the order of submicron, although the size may depend on the viscosity of the liquid. Since all the particulate substances of such a size are captured when they pass through the filters 7, no splash of blood and volatized matter would leak to the outside of the biochemical reaction cartridge 1 with air. Particularly, since the filters 7a and 7k are arranged respectively on the flow channels 4a and 4k, while the filter 7o is arranged on the flow channel 4o, the splash of blood, if any, containing bacteria and/or viruses that are still alive and floating in the inside of the biochemical reaction cartridge 1 is captured by the filters 7a and 7k and would not come out from the biochemical reaction cartridge 1 in Step S1.

Referring to FIG. 6 again, only the nozzle inlet ports 3b, 3k are opened in Step S2 and the second hemolyzing agent in the chamber 5b is driven to flow into the chamber 8 in a similar manner. Then, only the nozzle inlet ports 3c and 3k are opened in Step S3 and the magnetic particles in the chamber 5c are driven to flow into the chamber 8 in a similar manner. In Steps S2 and S3, the solution is stirred as in the same manner as step S1. Thus, the DNA obtained as a result of lysing blood cells in Steps S1 and S2 adheres to the magnetic particles in Step S3. Since the process of treating the sample, which is blood, by means of the first and second hemolyzing agents has progressed to a considerable degree at this stage of operation, the safety problem of preventing secondary infections of bacteria and/or viruses in the blood is lessened. However, the problem of contamination remains in the biochemical reaction cartridge 1 of this embodiment and the biochemical processor 30 that are designed to examine the presence or absence of DNA. On the other hand, since the filters 7a through 7j, 7k, 7l, 7m, 7o, 7r and 7t that are made of nonwoven fabric are arranged respectively on the flow channels 4a through 4j, 4k, 4l, 4m, 4o, 4r and 4t as described above, neither the DNA separated from the sample nor the DNA remaining in the sample would go out of the biochemical reaction cartridge 1 as a splash and adhere to and accumulate in the biochemical processor 30, in the inside of the pump nozzles 21 and 22 to be more specific. Therefore, if the process of some other biochemical reaction cartridge 1 is conducted immediately thereafter, no problem of contamination arises and the obtained outcome of the analysis is highly reliable. The effects of the filters 7 also appear in all the steps that come after Step S4, which will be described below. The filters are preferably arranged at respective positions where they do not contact any pump nozzle when the pump nozzle is inserted into the corresponding nozzle inlet port.

Then, in Step S4, the electromagnet 15 is activated and only the nozzle inlet ports 3e and 3k are opened to eject air from the motor-drive syringe pump 20 and suction air from the motor-driven syringe pump 19 in order to drive the solution in the chamber 8 to move into the chamber 5e. At the time of this movement, the magnetic particles and the DNA are captured on the electromagnet 15 in the flow channel 11. The efficiency of capturing DNA is improved when the air suctioning operation and the air ejecting operation of the motor-driven syringe pumps 19 and 20 are conducted alternately and repeatedly to make the solution move between the chamber 8 and the chamber 5e twice. The efficiency of capturing DNA is further improved when the number of times of movements of the solution is increased.

Thus, DNA is captured in a small flow channel that is about 1.0 to 2.0 mm wide and about 0.2 to 1.0 mm high by utilizing magnetic particles while the DNA is flowing. Therefore, it can be captured highly efficiently. The above description applies to a situation where the target substance to be captured is RNA or protein.

Then, electromagnet 15 is deactivated in Step S5 and only the nozzle inlet ports 3f and 31 are opened to eject air from the motor-driven syringe pump 20 and suction air from the motor-driven syringe pump 19 in order to drive the first extractant/detergent solution in the chamber 51 to move into the chamber 5f. At this time, both the magnetic particles and the DNA captured in Step S4 are moved with the extractant/detergent solution and washed. After moving the solution between the chamber 5l and the chamber 5f twice as in Step S4, the electromagnet 15 is activated to drive the solution to move twice in a similar manner and collect the magnetic particles and the DNA on the electromagnet 15 on the flow channel 11 and then the solution is returned to the chamber 51.

In Step S6, an operation same as that of Step S5 is conducted on the second extractant/detergent solution in the chamber 5m, using the nozzle inlet ports 3f and 3m, to further wash the magnetic particles and the DNA. In Step S7, only the nozzle inlet ports 3d and 3o are opened, while the electromagnet 15 is held in the activated state, to eject air from the motor-driven syringe pump 19 and suction air from the motor-driven syringe pump 20 in order to drive the extractant solution in the chamber 5d to move into the chamber 9.

At the time of this movement, the magnetic particles and the DNA are separated from each other under the effect of the extractant solution and only the DNA is driven to move into the chamber 9 with the extractant solution, while the magnetic particles remain in the flow channel 11. In this way, the DNA is extracted and refined. Thus, it is possible to extract and refine DNA in the biochemical reaction cartridge 1 because chambers containing respectively the first and second extractant/detergent solutions and chambers for receiving and storing respective waste solutions are provided.

Then, in Step S8, only the nozzle inlet ports 3g and 3o are opened to eject air from the motor-driven syringe pump 19 and suction air from the motor-driven syringe pump 20 in order to drive the PCR agent (TaKaRa EX Taq™) in the chamber 5g to flow into the chamber 9. Then, only the nozzle inlet ports 3g and 3t are opened and air is ejected and suctioned alternately and repeatedly by means of the motor-driven syringe pumps 19 and 20. In this way, the operation of driving the solution in the chamber 9 to flow to the flow channel 12 and driving it to flow back is repeated in order to stir the solution. Then, the Peltier element 16 is controlled to maintain the temperature of the solution in the chamber 9 to 96° C. for ten minutes and subsequently a heating and cooling sequence of maintaining it to 96° C. for ten seconds, to 55° C. for ten seconds and to 72° C. for one minute is repeated for thirty times in order to amplify the extracted DNA by means of the polymerase chain reaction (PCR) process.

Subsequently, in Step S9, only the nozzle inlet ports 3g and 3t are opened to eject air from the motor-drive syringe pump 19 and suction air from the motor-driven syringe pump 20 in order to drive the solution in the chamber 9 to move into the chamber 10. Additionally, the Peltier element 17 is controlled to maintain the temperature of the solution in the chamber 10 to 45° C. for two hours for a process of hybridization. At this time, air is ejected and suctioned alternately and repeatedly by means of the motor-driven syringe pumps 19 and 20. In this way, the operation of driving the solution in the chamber 10 to flow to the flow channel 6t and driving it to flow back is repeated in order to stir the solution and make the hybridization to progress.

Then, in Step S10, only the nozzle inlet ports 3h and 3r are opened to eject air from the motor-drive syringe pump 19 and suction air from the motor-driven syringe pump 20 in order to drive the solution in the chamber 10 to move into the chamber 5r so as to flow the first detergent solution in the chamber 5h into the chamber 5r through the chamber 10, while maintaining the temperature to 45° C. continuously. The air suctioning operation and the air ejecting operation of the motor-driven syringe pumps 19 and 20 are conducted alternately and repeatedly to make the solution move among the chambers 5h, 10 and 5r twice and finally the solution is returned to the chamber 5h. In this way, the fluorescence-labeled sample DNA that has not been hybridized and the fluorescent labeling substance are washed.

FIG. 8 is a schematic cross sectional view of a part of the biochemical reaction cartridge taken across the chambers 5h, 10 and 5r shown in FIG. 2. It shows that the pump nozzle 21 is inserted into the nozzle inlet port 3h to increase the internal pressure, while the pump nozzle 22 is inserted into the nozzle inlet port 3r to decrease the internal pressure so as to flow the first detergent solution in the chamber 5h into the chamber 5r by way of the chamber 10. The filter 7h is arranged on the flow channel 4h, while the filter 7r is arranged on the flow channel 4r.

Referring back to FIG. 6, in Step S11, the nozzle inlet ports 3j and 3r are used to conduct a washing operation same as that of Step S10 by means of the second detergent solution in the chamber 5j, which detergent solution is then finally returned to the chamber 5j, while maintaining the temperature to 45° C. continuously. Thus, it is possible to wash the DNA micro-array 13 in the biochemical reaction cartridge 1 because the chambers 5h and 5j containing respective detergent solutions and the chamber 5r for receiving and storing waste solutions after the washing operation are provided.

Then, in Step S12, only the nozzle inlet ports 3i and 3r are opened to eject air from the motor-drive syringe pump 19 and suction air from the motor-driven syringe pump 20 in order to drive the alcohol in the chamber 5i to move into the chamber 5r by way of the chamber 10. Thereafter, only the nozzle inlet ports 3i and 3t are opened to eject air from the motor-drive syringe pump 19 and suction air from the motor-driven syringe pump 20 in order to dry the inside of the chamber 10.

As the examiner operates a lever (not shown), the pump blocks 23 and 24 move away from the biochemical reaction cartridge 1 and the pump nozzles 21 and 22 leave the nozzle inlet ports 3 of the cartridge 1. Then, the examiner puts the cartridge 1 into a well-known DNA micro-array reading apparatus such as a scanner for the purpose of measurement and analysis.

### Embodiment 2

Now, the second embodiment of the invention will be described by referring to the related drawings.

While air permeable filters are used to capture any splash and/or volatized matter of the solution in the biochemical reaction cartridge 1 in the above described first embodiment, a fine tube structure is arranged in each of the communication channels of this embodiment to provide effects that are equivalent to those of the first embodiment. Since this embodiment is identical with the first embodiment in terms of fundamental configuration, the same components are denoted by the same reference symbols and will not be described any further.

Since the appearance of the biochemical reaction cartridge 1 of this embodiment is same as that of the first embodiment, it will not be described here any further.

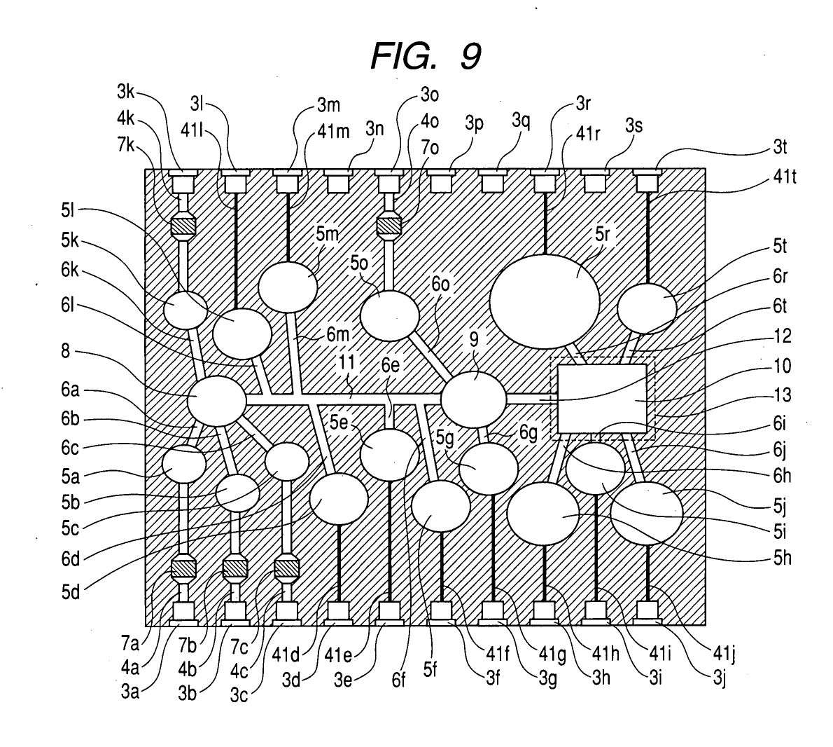

FIG. 9 is a schematic cross sectional plan view of the biochemical reaction cartridge 1 of this embodiment. The embodiment has a configuration basically same as that of the embodiment of FIG. 2. Referring to FIG. 9, a total of ten nozzle inlet ports 3a through 3j are arranged at one of the pair of lateral surfaces and another ten nozzle inlet ports 3k through 3t are arranged at the opposite lateral surface. Each of the nozzle inlet ports 3a through 3t is held in communication with the corresponding one of the chambers 5, which is a site for storing solution or causing a reaction to take place, by way of the corresponding one of airflow channels 4 and airflow channel 4l that are communication channels through which airflows.

Note, however, that the nozzle inlet ports 3n, 3p, 3q and 3s are not in use and not connected to the respective chambers 5 in the process of the embodiment. In other words, the nozzle inlet ports 3n, 3p, 3q and 3s are spares. Thus, the nozzle inlet ports 3a through 3c, 3k and 3o are respectively held in communication with the chambers 5a through 5c, 5k and 5o by way of the airflow channels 4a through 4c, 4k and 4o, while the nozzle inlet ports 3d through 3j, 3l, 3m, 3r and 3t are respectively held in communication with the chambers 5d through 5j, 5l, 5m, 5r and 5t by way of the airflow channels 41d through 41j, 41l, 41m, 41r and 41t.

The airflow channels 4a through 4c and the airflow channels 4k and 4o are provided respectively on the way thereof with filters 7a through 7c, 7k and 7o that are made of nonwoven fabric. The filters 7 are arranged in the biochemical reaction cartridge 1 in a manner same as the one described above for the first embodiment and hence will not be described here any further.

The internal configuration of the biochemical reaction cartridge 1 is same as the one described above for the first embodiment and hence will not be described here any further.

The biochemical processor for controlling the movements of solution and various reactions in the biochemical reaction cartridge 1 is same as the one described above for the first embodiment by referring to FIG. 3 and hence will not be described here any further.

While the main body of the biochemical reaction cartridge 1 of this embodiment may be manufactured by way of any of a number of different processes, they are the same as those described above for the first embodiment and hence will not be described here any further.

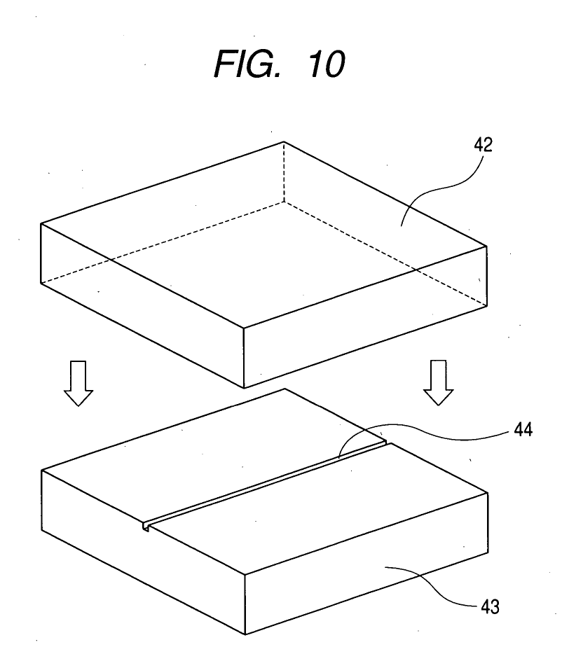

FIG. 10 is a schematic perspective view illustrating the configuration of a airflow channel 41. Referring to FIG. 10, the biochemical reaction cartridge 1 is formed by bonding the uppermost layer 42 and the second uppermost layer 43. The second layer 43 is provided with a groove 44, which becomes a tubular airflow channel 41. The airflow channels 41 of this embodiment show a square cross section that is 0.5 mm wide and 0.5 mm deep. In other words, the cross section has an area B of 0.25 mm². The flow channel 41 from each chamber 5 to the corresponding connecting section 3 has to be not less than 15 mm long. While each flow channel 41 has a relatively small cross sectional area and a relatively large length, the resistance of the flow channel against the airflow is small because the viscosity of air is small. As the airflow channels 41 are made to show a fine tube structure, the splash of the solution in the inside of the biochemical reaction cartridge 1 that may be air borne can easily adhere to the inner surfaces of the airflow channels 41 and become captured. Thus, it is possible to make the air coming out from the biochemical reaction cartridge 1, passing through any of the airflow channels 41, clean and free from any splash that may contain bacteria and/or viruses coming from the sample.

The phenomenon that a splash of solution adheres to the inner surface of an airflow channel 41 is that of adsorption of liquid relative to solid. While the phenomena of adsorption may be either chemical adsorption that is based on inter-atomic force or physical adsorption that is based on inter-molecular force, the phenomenon that a splash of solution adheres to the inner surface of any of the airflow channels 41 of this embodiment can be described primarily as physical adsorption. It is well known that the phenomenon of physical adsorption relies to a large extent on the magnitude of the surface energy of the solid in question. More specifically, when the surface energy of the solid is large, the solid is highly hydrophilic and can easily become wet with liquid. When, to the contrary, the surface energy of the solid is small, the solid is highly hydrophobic (water-repellent) and can hardly become wet with liquid.

It is a requirement to be met that the inner surfaces of the airflow channels 41 show a large surface energy and can easily become wet with liquid. The biochemical reaction cartridge 1 of this embodiment is made of transparent or semitransparent synthetic resin that may be polymethyl methacrylate (PMMA), acrylonitrile-butadiene-styrene (ABS) copolymer, polystyrene, polycarbonate, polyester, polyvinylchloride or the like. The above cited synthetic resins show a surface energy level of about 35 to 50 mN/m and hence can relatively easily become wet with liquid. It is well known that the surface energy of a solid can be raised to make the surface of the solid easily wettable with liquid by irradiating plasma onto the solid. As described earlier, the biochemical reaction cartridge 1 is formed by bonding the uppermost layer 42 and the second uppermost layer 43. The surface energy of the inner surfaces of the airflow channels 41 can be raised to increase the hydrophilicity of the inner surfaces so that splashes of liquid may be captured with ease by irradiating the lower surface of the uppermost layer 42 and the inner wall surfaces of the grooves 44 of the second uppermost layer 43 with plasma before bonding the two layers. While the Reynolds number Re of an airflow channel 41 is determined by the diameter (the size of the cross section) of the flow channel and the kinematic viscosity of air, it can be held to less than a certain level by minimizing the diameter of the airflow channel because the kinematic viscosity of air is small. Since the flow rate of airflowing through the airflow channels is about 10 to 100 mm/sec in this embodiment, it is desirable to reduce the cross section of each of the airflow channels in order to make the flow of airflowing through the airflow channel not a laminar flow but a turbulent flow. As pointed out above, the airflow channels 41 of this embodiment are 0.5 mm wide and 0.5 mm deep and hence the cross section thereof has an area of 0.25 mm². When the airflow in an airflow channel 41 is a laminar flow, any splash of liquid that can be contained in air flies substantially in parallel with the inner wall of the airflow channel 41 so that the probability of being caught by the wall surface of the airflow channel 41 is low. When, on the other hand, the airflow in an airflow channel 41 is a turbulent flow, any splash of liquid that can be contained in air flies irregularly so that the probability of being caught by the wall surface of the airflow channel 41 is high. As pointed out above, the airflow in the airflow channel 41 is either a laminar flow or a turbulent flow depending on the cross sectional area of the flow channel, the kinematic viscosity of air and the airflow rate. The cross section of the airflow channels 41 of this embodiment that is 0.5 mm wide and 0.5 mm deep, or the cross sectional area of 0.25 mm² of the airflow channels 41, is effective as a rule of thumb. Additionally, the flow channel 41 from each chamber 5 to the corresponding connecting section 3 is not less than 15 mm long in this embodiment. While the length of the flow channel 41 is not related to the Reynolds number Re, the longer the flying distance of a splash of solution in an airflow channel 41, the higher the probability of being caught by the wall surface of the airflow channel 41. Thus, the length not less than 15 mm of this embodiment is effective as a rule of thumb.

An analytical process in this embodiment starts when the examiner inputs an instruction for starting the process at the input section 25. The sequence of operation of the processor to which this embodiment is applied is same as that of the first embodiment described above by referring to the flow chart of FIG. 6 and hence will not be described here any further.

### Embodiment 3

Now, the third embodiment of the present invention will be described below by referring to the related drawings.

The airflow channels of the above described second embodiment, or communication channels through which air flows, are made to show a fine tube structure for the purpose of capturing any splash of solution and/or volatized matter in the biochemical reaction cartridge 1 so as to make them operate as effective as filters. On the other hand, each of the airflow channels of this embodiment is provided with two or more than two bent sections to make it operate as effective as a filter. The provision of bent sections alleviates the requirement of cross sectional area and length. More specifically, the machining accuracy may be less rigorous when the cross sectional area is allowed to be larger and the biochemical reaction cartridge 1 can be downsized when the length of each flow channel is allowed to be shorter.

Thus embodiment has a configuration basically same as that of the first and second embodiments and hence the components of this embodiment are denoted respectively by the same reference symbols and will not be described any further.

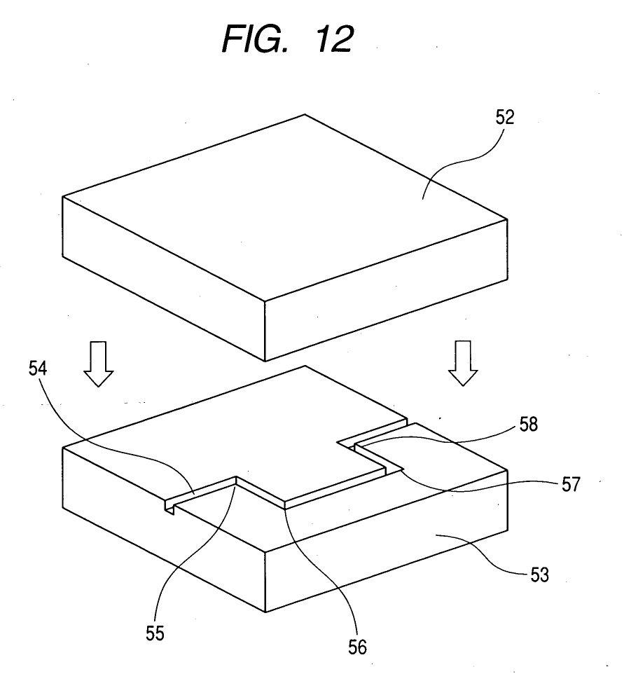

A bent section of a flow channel may be a so-called “bend” where the flow channel turns mildly or a so-called “elbow” where the flow channel turns abruptly from the viewpoint of fluid mechanics. Weisbach's empirical formulas are known for them. In this embodiment, the bent sections are elbows as shown in FIG. 12. According to the applicable Weisbach's empirical formula, the loss coefficient for a bending angle of 90° is close to 1 (0.9855). The provision of bent sections increases the loss of energy in terms of fluid mechanics and, at the same time, gives rise turbulences, or a turbulent flow, even the flow rate of fluid is relatively low and produces a laminar flow. As a result, any splash that can be contained in air will be caught by the wall surface of the airflow channel 51 at an increased probability. Additionally, the provision of bent sections allows to increase the cross sectional area of the flow channels 51 to several times of the cross sectional area of the flow channels 41 of the second embodiment.

Since the appearance of the biochemical reaction cartridge 1 of this embodiment is same as that of the first embodiment and that of the second embodiment, it will not be described here any further.

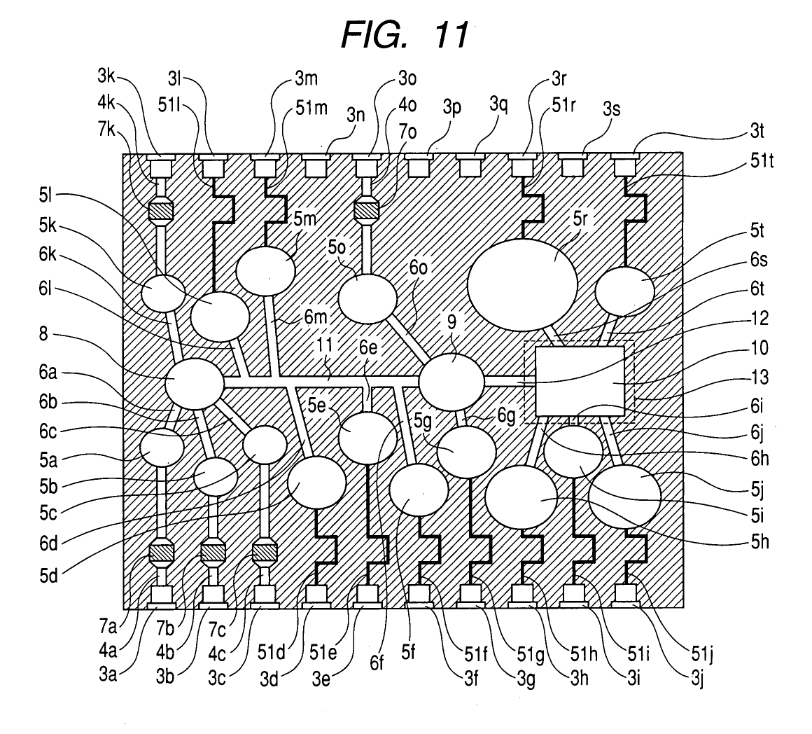

FIG. 11 is a schematic cross sectional plan view of the biochemical reaction cartridge 1 of this embodiment. The embodiment has a configuration basically same as that of the embodiment of FIG. 2. Referring to FIG. 11, a total of ten nozzle inlet ports 3a through 3j are arranged at one of the pair of lateral surfaces and another ten nozzle inlet ports 3k through 3t are arranged at the opposite lateral surface. Each of the nozzle inlet ports 3a through 3t is held in communication with the corresponding one of the chambers 5, which is a site for storing solution or causing a reaction to take place, by way of the corresponding one of airflow channels 4 and airflow channel 51 that are communication channels through which airflows.

Note, however, that the nozzle inlet ports 3n, 3p, 3q and 3s are not in use and not connected to the respective chambers 5. In other words, the nozzle inlet ports 3n, 3p, 3q and 3s are spares. Thus, the nozzle inlet ports 3a through 3c, 3k and 3o are respectively held in communication with the chambers 5a through 5c, 5k and 5o by way of the airflow channels 4a through 4c, 4k and 4o, while the nozzle inlet ports 3d through 3j, 3l, 3m, 3r and 3t are respectively held in communication with the chambers 5d through 5j, 5l, 5m, 5r and 5t by way of the airflow channels 51d through 51j, 51l, 51m, 51r and 51t.

The airflow channels 4a through 4c and the airflow channels 4k and 4o are provided respectively on the way thereof with filters 7a through 7c, 7k and 7o that are made of nonwoven fabric. The filters 7 are arranged in the biochemical reaction cartridge 1 in a manner same as the one described above for the first embodiment and hence will not be described here any further.

The internal configuration of the biochemical reaction cartridge 1 is same as the one described above for the first embodiment and hence will not be described here any further.

The biochemical processor for controlling the movements of solution and various reactions in the biochemical reaction cartridge 1 is same as the one described above for the first embodiment by referring to FIG. 3 and hence will not be described here any further.

While the main body of the biochemical reaction cartridge 1 of this embodiment may be manufactured by way of any of a number of different processes, they are same as those described above for the first embodiment and hence will not be described here any further.

FIG. 12 is a schematic perspective view of a part of the embodiment of biochemical reaction cartridge of FIG. 11, illustrating the configuration of a flow channel 51 thereof. Referring to FIG. 12, 52 denotes the uppermost layer of the biochemical reaction cartridge 1 and 53 denotes the second uppermost layer of the biochemical reaction cartridge 1. The second layer 53 is provided with a groove 54, which becomes a tubular flow channel 51 as the uppermost layer 42 and the second uppermost layer 43 are laid one on the other and bonded to each other. The flow channel 51 of this embodiment is provided four bent sections including the bent sections 55, 56, 57 and 58. While the flow channel 51 has a small cross sectional area and provided with bent sections, the resistance of the flow channel against air is small because the viscosity of air is very small. However, the cross sectional area of the flow channel 51 of this embodiment does not need to be as small as that of the corresponding flow channel 41 of the above described second embodiment. Since the flow channel 51 is provided with bent sections, any splash of solution that can be contained in air in the inside of the biochemical reaction cartridge 1 will easily adhere to and become caught by the inner surface of the flow channel 51 mainly when the airflow in the flow channel 51 is forced to shift its direction at each of the bent sections. Thus, it is possible to make the air coming out from the biochemical reaction cartridge 1, passing through any of the airflow channels 51, clean and free from any splash that may contain bacteria and/or viruses coming from the sample.

Additionally, the flow channels 51 of this embodiment may be made to show a complex structure (labyrinth structure) where each flow channel 51 is branched and some of the branches are not provided with any exit so that the exit of each flow channel 51 is not identifiable relative to the entrance thereof.

An analytical process in this embodiment starts when the examiner inputs an instruction for starting the process at the input section 25. The sequence of operation of the processor to which this embodiment is applied is same as that of the first embodiment described above by referring to the flow chart of FIG. 6 and hence will not be described here any further.

The present invention is not limited to the above described embodiments and various changes and modifications can be made within the spirit and scope of the present invention. Therefore, to apprise the public of the scope of the present invention, the following claims are made.

This application claims priority from Japanese Patent Application No. 2004-207241 filed Jul. 14, 2004, which is hereby incorporated by reference herein.

1. A biochemical reaction cartridge comprising:
a plurality of chambers for containing a solution for biochemically processing a sample;
communication channels communicating with said chambers; and connecting sections connected respectively to said communication channels; each of said communication channels being provided with a captor member for capturing any splash and/or volatilized matter of the sample itself, the solution for biochemically processing the sample or a mixture thereof.

2. The cartridge according to claim 1, wherein said communication channels allow the bacteria and/or viruses contained in the sample to exist alive therein.

3. The cartridge according to claim 1, wherein said captor member is an air permeable filter.

4. The cartridge according to claim 3, wherein said filter comprises one or more than one selected from a filter of nonwoven fabric, a HEPA filter, an ULPA filter and a germicidal enzyme filter.

5. The cartridge according to claim 1, wherein said captor member is a fine tube structure of each of said communication channels.

6. The cartridge according to claim 5, wherein said captor member is a bent section of each of said communication channels.

7. The cartridge according to claim 5, each of said communication channels has an average cross sectional area of not greater than 0.25 mm² and a length of not smaller than 15 mm from the corresponding chamber to the corresponding connecting section.

8. The cartridge according to claim 5, wherein said communication channels have a labyrinth structure.

9. The cartridge according to claim 1, wherein the solution for biochemically processing the sample is contained in said plurality of chambers.

10. A method of using a biochemical reaction cartridge, said biochemical reaction cartridge comprising:
a plurality of chambers for containing a solution for biochemically processing a sample;
communication channels communicating with said chambers; and
connecting sections connected respectively to said communication channels; each of said communication channels being provided with a captor member for capturing any splash and/or volatilized matter of the sample itself, the solution for biochemically processing the sample or a mixture thereof; said method controlling a movement of liquid in the biochemical reaction cartridge by controlling the air pressure in the inside of said cartridge by way of the connecting sections.

11. The cartridge according to claim 2, wherein said captor member is an air permeable filter
